(19) United States
(12) Patent Application Publication
(10) Pub. No.: US 2023/0137902 A1
(43) Pub. Date: May 4, 2023

(54) POLYESTER FILM, LAMINATE SHEET AND FLEXIBLE DISPLAY APPARATUS COMPRISING SAME

(71) Applicant: SKC CO., LTD., Gyeonggi-do (KR)

(72) Inventors: Gun Uk KIM, Gyeonggi-do (KR); Jin-Seok PARK, Gyeonggi-do (KR); Sang Min CHOI, Gyeonggi-do (KR)

(21) Appl. No.: 17/515,303

(22) Filed: Oct. 29, 2021

(51) Int. Cl. G09F 9/30; B32B 27/36; C08L 33/04; C08L 79/08; C08J 5/18; B32B 27/18; B32B 7/023

(52) U.S. Cl. CPC G09F 9/301; B32B 27/36; C08L 33/04; C08L 79/08; C08J 5/18; B32B 27/18; B32B 7/023; B32B 2457/20; B32B 2307/42; B32B 2307/546

(57) ABSTRACT

In the polyester film according to an embodiment, the transmittance for a specific wavelength and the strain for a tensile load to certain ranges when exposed to UV light, whereby it is possible to enhance the UV durability and flexibility at the same time. Accordingly, the polyester film and the laminated sheet comprising the same can be applied to a cover of a flexible display device, in particular, a foldable display device to prevent the poor or deformed appearance or the occurrence of device defects during repeated folding and exposure to UV light for long-term use.

### TECHNICAL FIELD

Embodiments relate to a polyester film with enhanced UV durability and flexibility, to a laminated sheet, and to a flexible display device comprising the same.

### BACKGROUND ART

Display technologies continue to develop driven by the demand in tandem with the development in IT devices. Technologies on curved displays and bent displays have already been commercialized. In recent years, flexible display devices that can be flexibly bent or folded in response to an external force are preferred in the field of mobile devices that require large screens and portability at the same time. In particular, a foldable display device has the great advantage that it is folded to a small size to enhance its portability when not in use, and it is unfolded to form a large screen when used.

These flexible display devices mainly use a transparent polyimide film or ultra-thin glass (UTG) as a cover window. A transparent polyimide film is vulnerable to scratches from the outside, and ultra-thin glass has a problem in that the scattering prevention characteristics are poor; therefore, a protective film is applied to the surface thereof In a film applied to a foldable display device, a tensile load continues to be applied to the film in the folded state. If the film is deformed in this state, the layers may be delaminated from each other.

In order to prevent the above problem, a polymer film made of a soft material, for example, an elastomer that does not easily deform even when a certain load is applied for a long period of time may be used as a protective film However, there arise problems in that an elastomer-based polymer has sticky characteristics, which makes the process control difficult, it is difficult to prepare a flawless transparent film due to the presence of gels, resulting in a feeling of heterogeneity with the cover window, it is difficult to prepare a thin film, and it is readily deformed by an external impact such as pressing.

Further, since a display device used in mobile devices such as mobile phones is likely to be exposed to UV light, a function capable of preventing deformation of internal components is required for a protective film

### Prior Art Document

(Patent Document 1) Korean Laid-open Patent Publication No. 2017-0109746

### DISCLOSURE OF INVENTION

### Technical Problem

In recent years, polyethylene terephthalate (PET) films have been considered as a protective film applied to a cover of a flexible display device. However, it has the problem of poor elastic restoring capability, that is, flexibility required for the application to flexible display devices. In addition, since a general polyester film does not have UV durability, when it is used as a protective film for a display device, UV light may cause yellowing or impair the performance of the display panel.

Meanwhile, if a large amount of a UV blocking agent is added or if a film is modified to simply increase its flexibility in order to solve this problem, the mechanical properties and appearance characteristics or processability of the polyester film may be impaired.

As a result of the research conducted by the present inventors, it has been possible to provide a polyester film with enhanced UV durability and flexibility at the same time by adjusting the transmittance for a specific wavelength and the strain for a tensile load to certain ranges when exposed to UV light.

In addition, as a result of the research conducted by the present inventors, it has been possible to provide a laminated sheet with enhanced UV durability and flexibility at the same time by laminating two polyester films on both sides of a transparent substrate and adding a certain amount of a UV blocking agent to the film placed on the outside of the display and adding a UV blocking agent to the other film if necessary, thereby adjusting the characteristics and transmittance with respect to a wavelength of the respective films

Accordingly, an object of the embodiments is to provide a polyester film with suppressed deformation even after exposure to UV light and repeated folding, a laminated sheet, and a flexible display device comprising the same.

### Solution to Problem

According to an embodiment, there is provided a polyester film having a total transmittance of 5% or less for light having a wavelength of 370 nm and a final tensile rate of 3% or less when a load of N2% is applied for 1 hour in a first direction in the plane upon irradiation with UV-B light for 24 hours. Here, the load of N2% is a load that stretches the film by 2% relative to the initial state in the first direction, the UV-B light has a peak wavelength within 310 nm to 315 nm, an irradiance of 0.66 W/m² at a wavelength of 310 nm, and a total irradiance of 31.62 W/m² in the wavelength band of 250 nm to 400 nm.

According to another embodiment, there is provided a laminated sheet, which comprises a transparent substrate; a first polyester film disposed on one side of the transparent substrate; and a second polyester film disposed on the other side of the transparent substrate, wherein the first polyester film comprises (i) 0.5 part by weight to 2.0 parts by weight of a UV blocking agent relative to 100 parts by weight of the polyester resin contained in the first polyester film and has (ii) a total transmittance of 2% to 5.5% for light having a wavelength of 370 nm, (iii) a total transmittance of 9.5% to 22% for light having a wavelength of 380 nm, (iv) a total transmittance of 65% to 85% for light having a wavelength of 390 nm, and (v) a total transmittance of 85% to 95% for light having a wavelength of 550 nm.

According to still another embodiment, there is provided a flexible display device, which comprises a flexible display panel; and the polyester film disposed on the flexible display panel.

According to still another embodiment, there is provided a flexible display device, which comprises a flexible display panel; and a laminated sheet disposed on the flexible display panel, wherein the laminated sheet comprises a transparent substrate disposed on the flexible display panel; a first polyester film disposed on the transparent substrate; and a second polyester film disposed under the transparent substrate, wherein the first polyester film comprises (i) 0.5 part by weight to 2.0 parts by weight of a UV blocking agent relative to 100 parts by weight of the polyester resin contained in the first polyester film and has (ii) a total transmittance of 2% to 5.5% for light having a wavelength of 370 nm, (iii) a total transmittance of 9.5% to 22% for light having a wavelength of 380 nm, (iv) a total transmittance of 65% to 85% for light having a wavelength of 390 nm, and (v) a total transmittance of 85% to 95% for light having a wavelength of 550 nm.

### Advantageous Effects of Invention

According to the embodiment, it is possible to provide a polyester film with enhanced UV durability and flexibility at the same time by adjusting the transmittance for a specific wavelength and the strain for a tensile load to certain ranges when exposed to UV light.

In addition, according to the embodiment, it is possible to provide a laminated sheet with enhanced UV durability and flexibility at the same time by adding a certain amount of a UV blocking agent to the film placed on the outside of the display and adding a UV blocking agent to the other film if necessary among the two polyester films laminated on both sides of a transparent substrate, thereby adjusting the characteristics and transmittance with respect to a wavelength of the respective films.

Accordingly, the polyester film and laminated sheet can be applied to a cover of a flexible display device, in particular, a foldable display device to prevent the poor or deformed appearance or the occurrence of device defects during repeated folding and exposure to UV light for long-term use.

### BRIEF DESCRIPTION OF DRAWINGS

FIG. 1a shows an example of an in-folding type display device.

FIG. 1b shows an example of an out-folding type display device.

FIG. 2a is a perspective view of a display device from which the cover is disassembled.

FIG. 2b shows an example of a cross-sectional view of the cover of a display device.

FIG. 3 shows the spectra of transmittance of the Examples and Comparative Examples with respect to the wavelength of light.

FIG. 4 shows a method of durability test for repeated folding.

FIG. 5 shows a method of tensile test for a polyester film

FIG. 6 shows a curve of a tensile rate with respect to a load applied to a polyester film

FIG. 7 shows curves of a tensile rate (%) with respect to time (s) under a certain load applied to the polyester films of the Examples upon irradiation of UV light.

FIG. 8 shows curves of a tensile rate (%) with respect to time (s) under a certain load applied to the polyester films of the Comparative Examples upon irradiation of UV light.

FIG. 9 shows an example of a cross-sectional view of an organic light emitting display device.

<Explanation of Reference Numerals>

| | |
|---|---|
| 1: flexible display device | 1′: organic light emitting display device |
| 1a and 1b: in-folding and out- | |
| folding type flexible display | |
| devices | |
| 2: test equipment | 10: cover |
| 11: specimen | 20: display panel |
| 20-1: front polarizing plate | 20-2: organic light emitting display panel |
| 21: zig | 22: load cell |
| 30: frame | |
| 100: polyester film | 101: specimen |
| 100a: front protective film | 100b: rear protective film |
| 200: cover window | 300: adhesive layer |
| A, A′: cutting line | p1, p2: folding points |
| R: curvature | w: distance |

### BEST MODE FOR CARRYING OUT THE INVENTION

In the following description of the embodiments, in the case where an element is mentioned to be formed “on” or “under” another element, it means not only that one element is directly formed “on” or “under” another element, but also that one element is indirectly formed on or under another element with other element(s) interposed between them.

For the sake of description, the sizes of individual elements in the appended drawings may be exaggeratedly depicted, and they may differ from the actual sizes.

Throughout the present specification, when a part is referred to as “comprising” an element, it is understood that other elements may be comprised, rather than other elements are excluded, unless specifically stated otherwise.

In addition, all numbers expressing the physical properties, dimensions, and the like of elements used herein are to be understood as being modified by the term “about” unless otherwise indicated.

In the present specification, a singular expression is understood to encompass a singular or plural expression, interpreted in context, unless otherwise specified.

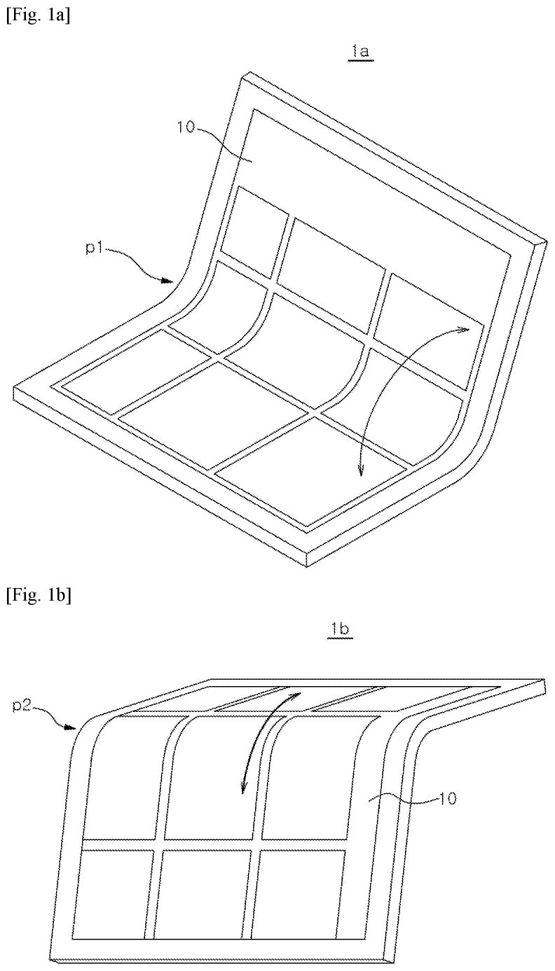

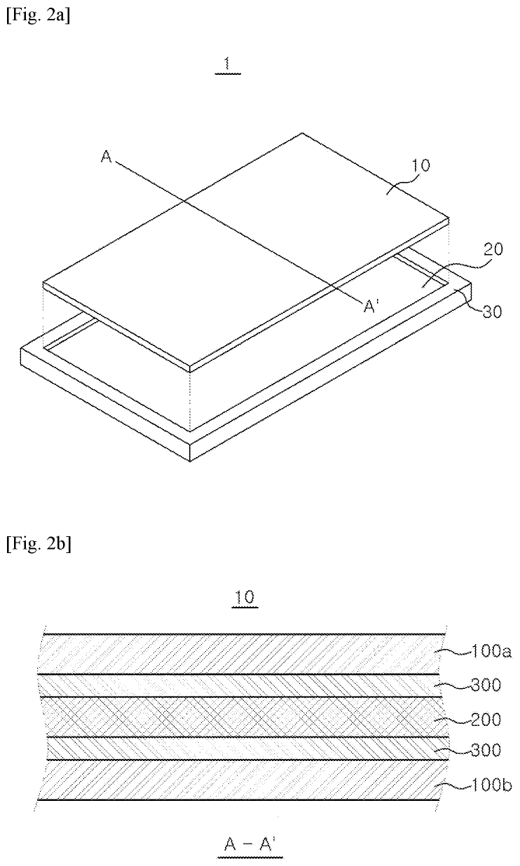

In recent years, foldable display devices have been developed as an in-folding type (1a), an out-folding type (1b), and the like as shown in FIGS. 1a and 1b. The polyester film applied to a cover (10) of these display devices has a high modulus at room temperature so that deformation may occur near the repeatedly folding points (p1, p2). In addition, since general polyester films do not have UV durability, as shown in FIG. 2a, when it is applied to a cover (10) of a display device, UV light is absorbed by the display panel (20) inside during long-term use, which may cause problems in operation.

The embodiments described below provide a polyester film with enhanced UV durability and flexibility at the same time by adjusting the transmittance for a specific wavelength and the strain for a tensile load to certain ranges when exposed to UV light, a laminated sheet, and a flexible displace device comprising the same.

Characteristics of a Polyester Film

When the polyester film according to an embodiment is applied to a cover of a display device, it is advantageous for preventing deformation by protecting the internal components thereof from UV light.

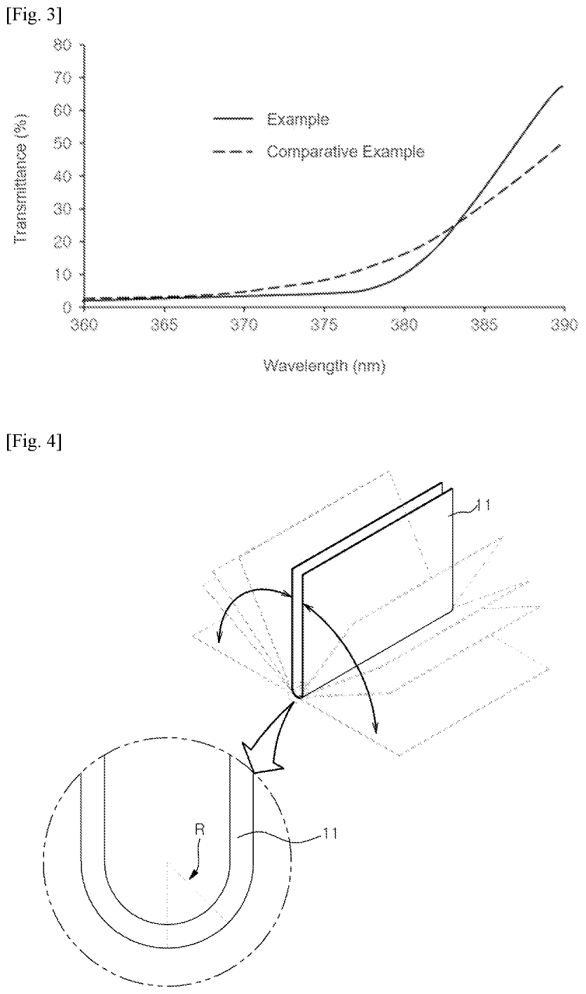

FIG. 3 shows the spectra of transmittance of the Examples and Comparative Examples with respect to the wavelength of light. As shown in FIG. 3, the Example and Comparative Example both show generally a low transmittance in the UV wavelength band, but there is a difference in the curves of the Example and Comparative Example in terms of transmittance at a specific wavelength.

Specifically, the curve of the Example maintains a very low transmittance until the end of the UV region (e.g., 370 nm). Then, the transmittance rapidly increases from the boundary (e.g., 380 nm), so that a significant level of transmittance is shown at the beginning of the visible light region (e.g., 390 nm). On the other hand, the curve of the Comparative Example shows that the transmittance gradually increases before the end of the UV region (e.g., 370 nm) to reach a certain level at the boundary (e.g., 380 nm), and it gently increases until the beginning of the visible light region (e.g., 390 nm).

As such, the polyester film may show a transmittance of a specific value or less at wavelengths of 370 nm and 380 nm and may show a transmittance of a specific value or more at a visible light wavelength such as 390 nm.

For example, the polyester film may have a total transmittance of 10% or less, 7% or less, 5.5% or less, 5% or less, 4.5% or less, or 4% or less, for light having a wavelength of 370 nm. The polyester film according to an embodiment has a total transmittance of 5% or less for light having a wavelength of 370 nm.

In addition, the polyester film may have a total transmittance of 30% or less, 25% or less, 22% or less, 20% or less, 15% or less, or 10% or less, for light having a wavelength of 380 nm. Specifically, the polyester film may have a total transmittance of 20% or less for light having a wavelength of 380 nm.

In addition, the polyester film may have a total transmittance of 45% or more, 50% or more, 55% or more, 60% or more, or 65% or more, for light having a wavelength of 390 nm. For example, the polyester film may have a total transmittance of 50% to 90%, 55% to 85%, or 60% to 80%, for light having a wavelength of 390 nm. In addition, the polyester film may have a total transmittance of 75% or more, 80% or more, 85% or more, 90% or more, or 95% or more, for light having a wavelength of 550 nm. As a specific example, the polyester film may have a total transmittance of 55% or more for light having a wavelength of 390 nm and a total transmittance of 85% or more for light having a wavelength of 550 nm.

As a specific example, the polyester film may have a total transmittance of 2% to 5.5% for light having a wavelength of 370 nm, a total transmittance of 9.5% to 22% for light having a wavelength of 380 nm, a total transmittance of 65% to 85% for light having a wavelength of 390 nm, and a total transmittance of 85% to 95% for light having a wavelength of 550 nm.

The polyester film may have an average rate of change in total transmittance (%) of 0.1%/nm to 1%/nm at a wavelength of 370 nm to 375 nm and an average rate of change in total transmittance (%) of 3%/nm to 10%/nm at a wavelength of 385 nm to 390 nm.

In addition, in the polyester film according to an embodiment, the strain with respect to tensile load is adjusted to a specific range even upon exposure to UV light. As a result, it is possible for the polyester film to maintain its original characteristics when applied to a cover of a flexible display device and subjected to a plurality of repeated folding upon exposure to UV light. The UV light may be, for example, UV-B light. The UV-B light may have a specific wavelength range of about 280 nm to 315 nm. Specifically, the UV-B light has a peak wavelength within 310 nm to 315 nm, an irradiance of about 0.66 W/m² (e.g., 0.6 to 0.7 W/m²) at a wavelength of 310 nm, and a total irradiance of about 31.62 W/m² (e.g., 31.6 to 31.7 W/m²) in the wavelength band of 250 nm to 400 nm.

The polyester film according to an embodiment, upon irradiation with UV-B light for 24 hours, has a final tensile rate of 3% or less when a load of N2% is applied for 1 hour in a first direction in the plane. Here, the load of N2% is a load that stretches the film by 2% relative to the initial state in the first direction. Specifically, the tensile rate may be measured at room temperature with an initial dimension of 50 mm (initial distance between points to which a tensile load is applied) of the film in the first direction and a dimension of 15 mm in a direction perpendicular thereto.

More specifically, (1) while the polyester film having an initial dimension of 50 mm in a first direction in the plane and a dimension of 15 mm in a direction perpendicular thereto is stretched in the first direction, the load (N2%) at the time when the dimension increases by 2% relative to the initial dimension is first measured, and (2) the ratio of the dimension increased relative to the initial dimension when the load (N2%) is continuously applied to the film for 1 hour in the first direction, that is, the final tensile rate is 3% or less.

As an example, the polyester film, upon irradiation with UV-B light for 24 hours, may have a final tensile rate of 3% or less, 2.7% or less, 2.5% or less, or 2.3% or less, when a load of N2% is applied for 1 hour. For example, the polyester film, upon irradiation with UV-B light for 24 hours, may have a final tensile rate of 1.5% to 3%, 2% to 3%, 2.3% to 3%, 2% to 2.7%, or 2% to 2.5%, in a first direction and a second direction perpendicular to each other in the plane, respectively, when a load of N2% is applied for 1 hour. Specifically, the polyester film, upon irradiation with UV-B light for 24 hours, may have a final tensile rate of 2% to 3% in a first direction and a second direction perpendicular to each other in the plane, respectively, when a load of N2% is applied for 1 hour.

As another example, the polyester film, upon irradiation with UV-B light for 24 hours, may have a final tensile rate of 2% or less when a load of N1% is applied for 1 hour in a first direction in the plane. Here, the load of N1% is a load that stretches the film by 1% relative to the initial state in the first direction. For example, the polyester film, upon irradiation with UV-B light for 24 hours, may have a final tensile rate of 1.7% or less, 1.5% or less, or 1.3% or less, when a load of N1% is applied for 1 hour. Specifically, the polyester film, upon irradiation with UV-B light for 24 hours, may have a final tensile rate of 1.1% to 2%, 1.3% to 2%, 1.5% to 2%, 1.1% to 1.7%, or 1.1% to 1.5%, in a first direction and a second direction perpendicular to each other in the plane, respectively, when a load of N1% is applied for 1 hour. The tensile rate may be measured at room temperature with an initial dimension of 50 mm of the film in the first direction and a dimension of 15 mm in a direction perpendicular thereto.

As still another example, the polyester film, upon irradiation with UV-B light for 24 hours, may have a final tensile rate of 7% or less when a load of N3% is applied for 1 hour in a first direction in the plane. Here, the load of N3% is a load that stretches the film by 3% relative to the initial state in the first direction. For example, the polyester film, upon irradiation with UV-B light for 24 hours, may have a final tensile rate of 6.7% or less, 6.5% or less, 6.3% or less, 6% or less, or 5.7% or less, when a load of N3% is applied for 1 hour. Specifically, the polyester film, upon irradiation with UV-B light for 24 hours, may have a final tensile rate of 3% to 7%, 5% to 7%, 5% to 6%, 5.5% to 6.5%, or 6% to 7%, in a first direction and a second direction perpendicular to each other in the plane, respectively, when a load of N3% is applied for 1 hour. The tensile rate may be measured at room temperature with an initial dimension of 50 mm of the film in the first direction and a dimension of 15 mm in a direction perpendicular thereto.

As a specific example, the polyester film, upon irradiation with UV-B light for 24 hours, may have a final tensile rate of 2% or less when a load of N1% is applied for 1 hour in a first direction in the plane and a final tensile rate of 7% or less when a load of N3% is applied for 1 hour in a first direction in the plane. Here, the load of N1% or N3% is a load that stretches the film by 1% or 3% relative to the initial state in the first direction.

The first direction may be any direction in the plane of the polyester film, and the second direction may be determined in a direction in the plane perpendicular to the first direction. For example, the first direction may be the longitudinal direction (MD) or the transverse direction (TD) of the film, and the second direction may be the transverse direction (TD) or the longitudinal direction (MD) perpendicular thereto. Specifically, the first direction may be the longitudinal direction (MD) of the film, and the second direction may be the transverse direction (TD) of the film.

FIG. 6 shows a curve of a tensile rate (%) with respect to a load (N) applied to a polyester film The loads of N1%, N2%, and N3% may be determined from the tensile rate curve with respect to the load, respectively. Specifically, in the polyester film, the load of N1% may be 28 N to 32 N, the load of N2% may be 50 N to 55 N, and the load of N3% maybe 64 N to 68 N.

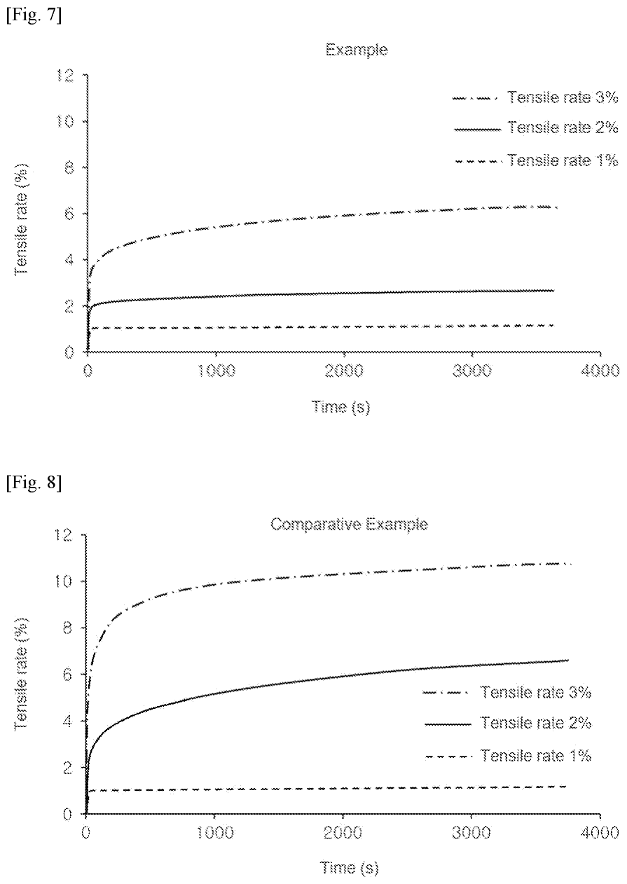

FIGS. 7 and 8 show curves of a tensile rate (%) with respect to time (s) under a certain load (N) applied to the polyester films of the Examples and Comparative Examples, respectively, upon irradiation with UV light. As described above, the polyester films of the Examples have a final tensile rate of 2% or less when a load of N1% is applied for 1 hour, a final tensile rate of 3% or less when a load of N2% is applied for 1 hour, and a final tensile rate of 7% or less when a load of N3% is applied for 1 hour, whereas the polyester films of the Comparative Examples do not meet these tensile characteristics.

The ratio of the load of N2% to the load of N1% may be 1.6:1 to 2.1:1. Specifically, the ratio of the load of N2% to the load of N1% may be 1.75:1 to 1.95:1. In addition, the ratio of the load of N3% to the load of N2% may be 1.2:1 to 1.5:1. Specifically, the ratio of the load of N3% to the load of N2% may be 1.20:1 to 1.35:1.

In addition, since the polyester film has excellent UV-blocking capability, when two sheets thereof are superposed and UV-B light is irradiated on the surface of one of the films for 24 hours, the physical properties of the other film disposed thereunder may not be deteriorated.

As an example, when two sheets of the polyester film are superposed and UV-B light is irradiated on one of the films for 24 hours, the other film may have a final tensile rate of 3% or less when a load of N2% is applied for 1 hour in a first direction in the plane.

As another example, when two sheets of the polyester film are superposed and UV-B light is irradiated on one of the films for 24 hours, the other film may have an elongation at break of 80% or more, for example, 85% or more, 100% or more, 120% or more, 125% or more, or 135% or more, specifically, 80% to 200%, 100% to 180%, or 135% to 160%. More specifically, when two sheets of the polyester film are superposed and UV-B light is irradiated on one of the films for 24 hours, the other film may have an elongation at break in the longitudinal direction (MD) of 125% or more and an elongation at break in the transverse direction (TD) of 85% or more. Here, the elongation at break refers to the tensile rate at break of the film at room temperature. The tensile rate may be measured at room temperature with an initial dimension of 50 mm of the film in the tensile direction and a dimension of 15 mm in a direction perpendicular thereto.

In addition, the polyester film, upon irradiation with UV-B light for 24 hours, may withstand 100 times or more, 1,000 times or more, 10,000 times or more, 50,000 times or more, 100,000 times or more, 150,000 times or more, or 200,000 times or more of repeated folding at a curvature radius of 1.5 mm until whitening or cracks occur. Specifically, the polyester film may withstand 200,000 times or more of repeated folding until whitening or cracks occur. Within the above range, it can be advantageously applied to a flexible display device since it is not deformed even upon repeated folding when exposed to UV light. The protective film can be applied to a cover of a flexible display device, in particular, a foldable display device by virtue of these characteristics.

The polyester film is preferably a biaxially stretched film from the viewpoint of flexibility and elastic restoring. In such an event, the ratio between the respective stretching ratios for the two directions may be 1:0.5 to 1:1.5, 1:0.7 to 1:1.3, or 1:0.8 to 1:1.2. Specifically, the polyester film may be biaxially stretched, and the ratio between the respective stretching ratios in the two directions may be 1:0.8 to 1:1.2. If the ratio of stretching ratios is within the above range, it may be more advantageous for having flexibility in which deformation does not occur even if a certain load is maintained for a long period of time.

The polyester film may be biaxially stretched in a first direction and in a second direction perpendicular to the first direction in the plane. In such an event, the stretching ratio in the first direction may be 2.0 to 5.0, specifically 2.8 to 3.5 or 3.3 to 3.5. In addition, the stretching ratio in the second direction may be 2.0 to 5.0, specifically 2.9 to 3.7 or 3.5 to 3.8. Specifically, the polyester film may be biaxially stretched at a stretching ratio of 3.3 to 3.5 in the longitudinal direction and at a stretching ratio of 3.5 to 3.8 in the transverse direction. In addition, the ratio (d2/d1) of the stretching ratio in the second direction (d2) to the stretching ratio in the first direction (d1) may be 1.2 or less. For example, it may be 1.0 to 1.2, 1.0 to 1.1, 1.0 to 1.15, or 1.05 to 1.1.

The polyester film may have a thickness of 10 μm to 500 μm, 10 μm to 300 μm, 10 μm to 100 μm, 10 μm to 80 μm, 20 μm to 80 μm, 30 μm to 80 μm, 40 μm to 60 μm, or 10 μm to 30 μm. For example, when the polyester film is applied as a protective film to a cover of a display device, it may have a thickness of 10 μm to 80 μm. As an example, when the polyester film is applied as a front protective film of a cover, it may have a thickness of 20 μm to 80 μm. As another example, when the polyester film is applied as a rear protective film of a transparent substrate, it may have a thickness of 30 μm or less, specifically, 10 μm to 30 μm.

Composition of a Polyester Film

The polyester film comprises a polyester resin.

The polyester resin may be a homopolymer resin or a copolymer resin in which a dicarboxylic acid and a diol are polycondensed. In addition, the polyester resin may be a blend resin in which the homopolymer resins or the copolymer resins are mixed.

Examples of the dicarboxylic acid include terephthalic acid, isophthalic acid, orthophthalic acid, 2,5-naphthalene dicarboxylic acid, 2,6-naphthalene dicarboxylic acid, 1,4-naphthalene dicarboxylic acid, 1,5-naphthalene dicarboxylic acid, diphenylcarboxylic acid, diphenoxyethane dicarboxylic acid, diphenylsulfonic acid, anthracenedicarboxylic acid, 1,3 -cyclopentanedicarboxylic acid, 1,3 -cyclohexanedicarboxylic acid, 1,4-cyclohexanedicarboxylic acid, hexahydroterephthalic acid, hexahydroisophthalic acid, malonic acid, dimethyl malonic acid, succinic acid, 3,3-diethyl succinic acid, glutaric acid, 2,2-dimethylglutaric acid, adipic acid, 2-methyladipic acid, pimelic acid, azelaic acid, sebacic acid, suberic acid, dodecadicarboxylic acid, and the like.

In addition, examples of the diol include ethylene glycol, propylene glycol, hexamethylene glycol, neopentyl glycol, 1,2-cyclohexanedimethanol, 1,4-cyclohexanedimethanol, decamethylene glycol, 1,3-propanediol, 1,4-butanediol, 1,5 -pentanediol, 1, 6-hexanediol, 2,2-bis(4-hydroxyphenyl)propane, bis(4-hydroxyphenyl)sulfone, and the like.

Preferably, the polyester resin may be an aromatic polyester resin having excellent crystallinity. For example, it may have a polyethylene terephthalate (PET) resin as a main component.

As an example, the polyester film may comprise a polyester resin, specifically a PET resin, in an amount of at least about 85% by weight, more specifically at least 90% by weight, at least 95% by weight, or at least 99% by weight. As another example, the polyester film may further comprise a polyester resin other than the PET resin. Specifically, the polyester film may further comprise up to about 15% by weight of a polyethylene naphthalate (PEN) resin. More specifically, the polyester film may further comprise a PEN resin in an amount of about 0.1% by weight to 10% by weight or about 0.1% by weight to 5% by weight.

The polyester film having the above composition can have increased crystallinity and enhanced mechanical properties in terms of tensile strength and the like in the process of preparing the same through heating, stretching, and the like.

The polyester film according to an embodiment comprises a UV blocking agent.

The content of the UV blocking agent in the polyester film may be 0.5 part by weight or more, 0.7 part by weight or more, 0.9 part by weight or more, 1.1 parts by weight or more, or 1.3 parts by weight or more, relative to 100 parts by weight of the polyester resin. In addition, the content of the UV blocking agent in the polyester film may be 2.4 parts by weight or less, 2.2 parts by weight or less, 2.0 parts by weight or less, 1.8 parts by weight or less, or 1.6 parts by weight or less, relative to 100 parts by weight of the polyester resin.

As an example, the polyester film comprises 100 parts by weight of a polyester resin; and 0.7 part by weight to 2.0 parts by weight of a UV blocking agent. Within the above range, it is advantageous for preventing the problem of poor appearance due to migration of the UV additive to the surface during or after the preparation of the film with the blocking capability for the UV region.

Meanwhile, if the UV blocking agent does not have sufficient thermal resistance, it may be decomposed in a significant amount when mixed with a polyester resin and extruded at high temperatures, which may adversely affect the UV blocking capability of the film Thus, it is preferable that the UV blocking agent has a weight reduction rate at a certain level or less at the melting temperature of the polyester resin. For example, the UV blocking agent may have a weight reduction rate of 20% or less, 15% or less, or 10% or less, when maintained for 1 hour in an air atmosphere at 280° C. under isothermal conditions of a thermogravimetric analyzer (TGA). Specifically, the UV blocking agent may have a weight reduction rate of 15% or less when maintained for 1 hour in an air atmosphere at 280° C. under isothermal conditions of a thermogravimetric analyzer (TGA). More specifically, the weight reduction rate may be 1% to 15%, 5% to 15%, or 10% to 15%.

The specific kind of the UV blocking agent is not particularly limited. For example, it may be at least one UV blocking agent selected from the group consisting of benzophenones, benzotriazoles, triazines, malonic acid esters, benzoates, and benzoxazinones.

As an example, the UV blocking agent may be a benzoxazinone-based UV blocking agent. Specifically, it may have one, two, or more benzoxazinone groups. More specifically, it may have two benzoxazinone groups linked around an unsaturated hydrocarbon chain or an aromatic ring.

As an example, the UV blocking agent may be at least one compound having a structure of the following Formula 1:

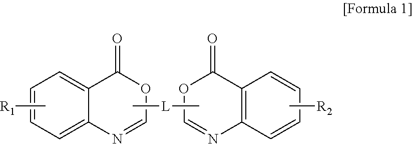

In the above formula, R1 and R2 are each independently hydrogen, alkyl, or alkenyl, and L is a single bond or a hydrocarbon chain, hydrocarbon ring, or heterocyclic ring having one or more unsaturated bonds.

The alkyl may be an alkyl having 1 to 6 carbon atoms, and the alkenyl may be an alkenyl having 2 to 6 carbon atoms. The hydrocarbon chain may have 2 to 10 carbon atoms, the hydrocarbon ring may have 6 to 20 carbon atoms, and the heterocyclic ring may be a 5- to 20-membered ring containing one or more heteroatoms selected from N, S, and O. In addition, the hydrocarbon ring or heterocyclic ring may be an aromatic ring. For example, the hydrocarbon ring may be a benzene ring, and the heterocyclic ring may be a pyridine ring.

L may be a group that forms a conjugation structure with two benzoxazinone groups connected thereto.

Process for Preparing a Polyester Film

Such a polyester film may be prepared by a process comprising biaxial stretching at an adjusted stretching ratio and thermal treatment at a specific temperature using a resin composition in which a UV blocking agent is mixed. In particular, the process for preparing a polyester film comprises forming a film from a resin composition and biaxially stretching and thermally treating it to obtain a film having a final tensile rate of 3% or less when a load of N2% is applied for 1 hour. Here, the composition and process conditions are adjusted such that the polyester film finally produced by the above process satisfies the tensile characteristics described above. Specifically, in order for the final polyester film to satisfy the above characteristics, the extrusion and casting temperatures of the polyester resin are adjusted, the preheating temperature at the time of stretching, the stretching ratio in each direction, the stretching temperature, the transferring speed, and the like are adjusted, or thermal treatment and relaxation are carried out after the stretching while the thermal treatment temperature and relaxation rate are adjusted.

Hereinafter, each step will be described in more detail.

First, a UV blocking agent is added to a polyester resin to prepare a resin composition. In such an event, the composition of the polyester resin and the type and content of the UV blocking agent are as exemplified above. Thereafter, the resin composition is melted and extruded to be cast into a film The extrusion may be carried out at a temperature of 230° C. to 300° C. or 250° C. to 280° C.

The film may be preheated at a certain temperature before stretching thereof. The preheating temperature satisfies the range of Tg+5° C. to Tg+50° C. based on the glass transition temperature (Tg) of the polyester resin, and it is determined to satisfy the range of 70° C. to 90° C. at the same time. Within the above range, the film may be soft enough to be readily stretched, and it is possible to effectively prevent the phenomenon of breakage during stretching thereof as well.

The stretching is carried out by biaxial stretching. For example, it may be biaxially stretched in the longitudinal direction (or machine direction; MD) and in the transverse direction (or tenter direction; TD) through a simultaneous biaxial stretching method or a sequential biaxial stretching method. Preferably, it may be carried out by a sequential biaxial stretching method in which stretching is first performed in one direction and then stretching is performed in the direction perpendicular thereto. The stretching speed may be 6.5 m/min to 8.5 m/min, but it is not particularly limited thereto.

The stretching ratio in the longitudinal direction may be 2.0 to 5.0, specifically 2.8 to 3.5 or 3.3 to 3.5. In addition, the stretching ratio in the transverse direction may be 2.0 to 5.0, specifically 2.9 to 3.7 or 3.5 to 3.8. Within the above preferred ranges, it may be more advantageous for obtaining a uniform thickness. In addition, in order to balance the longitudinal direction (MD) and the transverse direction (TD), it is preferable to adjust the load applied in each direction during stretching, while measuring the refractive index, so that the difference in the refractive index in each direction is minimized. In addition, the ratio (d2/d1) of the stretching ratio in the transverse direction (d2) to the stretching ratio in the longitudinal direction (d1) may be 1.2 or less. For example, it may be 1.0 to 1.2, 1.0 to 1.1, 1.0 to 1.15, or 1.05 to 1.1. The stretching ratios (d1, d2) refer to the ratios that represent the length after stretching as compared with the length before stretching, which is 1.0.

Thereafter, the stretched film is subjected to thermal treatment. The thermal treatment may be carried out at a temperature of 180° C. or higher, specifically 195° C. or higher, more specifically 195° C. to 230° C. The thermal treatment may be carried out for 0.2 minute to 1 minute, more specifically for 0.4 minute to 0.7 minute.

In addition, after the thermal treatment is initiated, the film may be relaxed in the longitudinal direction and/or in the transverse direction, and the temperature range therefor may be 150° C. to 250° C. The relaxation may be carried out at a relaxation rate of 1% to 10%, 2% to 7%, or 3% to 5%. In addition, the relaxation may be carried out for 1 second to 1 minute, 2 seconds to 30 seconds, or 3 seconds to 10 seconds.

In addition, the film may be cooled after the thermal treatment. The cooling may be carried out under a temperature condition lower than the thermal treatment temperature by 50° C. to 150° C.

Laminated Sheet

As shown in FIGS. 2a and 2b, the cover (10) of a display device (1) is disposed on a display panel (20). In the cover (10) of the display device, protective films (100a, 100b) are each laminated through an adhesive layer (300) on both sides of a transparent substrate (200). As such a cover (10) of a display device, a sheet in which a polyester film is laminated on both sides of a transparent substrate may be used.

The laminated sheet according to an embodiment comprises a transparent substrate; a first polyester film disposed on one side of the transparent substrate; and a second polyester film disposed on the other side of the transparent substrate. In the laminated sheet, the first polyester film comprises a UV blocking agent, and the second polyester film may, or may not, comprise a UV blocking agent.

In addition, the laminated sheet may further comprise an adhesive layer between the transparent substrate and the first polyester film and between the transparent substrate and the second polyester film

Since the laminated sheet comprises the UV blocking polyester film described above, it may have the same or similar UV blocking capability. That is, the laminated sheet may show a transmittance of a specific value or less at wavelengths of 370 nm and 380 nm and may show a transmittance of a specific value or more at a visible light wavelength such as 390 nm.

Thus, the laminated sheet according to an embodiment as a cover of a display device is advantageous for preventing deformation by protecting the internal components thereof from UV light.

For example, the laminated sheet may have a total transmittance of 10% or less, 7% or less, 5% or less, 4.5% or less, or 4% or less, for light having a wavelength of 370 nm. In addition, the laminated sheet may have a total transmittance of 30% or less, 25% or less, 20% or less, 15% or less, or 10% or less, for light having a wavelength of 380 nm. As a specific example, the laminated sheet may have a total transmittance of 5% or less for light having a wavelength of 370 nm and a total transmittance of 20% or less for light having a wavelength of 380 nm.

In addition, the laminated sheet may have a total transmittance of 45% or more, 50% or more, 55% or more, 60% or more, or 65% or more, for light having a wavelength of 390 nm. For example, the laminated sheet may have a total transmittance of 50% to 90%, 55% to 85%, or 60% to 80%, for light having a wavelength of 390 nm. In addition, the laminated sheet may have a total transmittance of 75% or more, 80% or more, 85% or more, 90% or more, or 95% or more, for light having a wavelength of 550 nm. As a specific example, the laminated sheet may have a total transmittance of 55% or more for light having a wavelength of 390 nm and a total transmittance of 85% or more for light having a wavelength of 550 nm.

The laminated sheet may have an average rate of change in total transmittance (%) of 0.1%/nm to 1%/nm at a wavelength of 370 nm to 375 nm and an average rate of change in total transmittance (%) of 3%/nm to 10%/nm at a wavelength of 385 nm to

In addition, the laminated sheet, upon irradiation with UV-B light for 24 hours, may withstand 100 times or more, 1,000 times or more, 10,000 times or more, 50,000 times or more, 100,000 times or more, 150,000 times or more, or 200,000 times or more of repeated folding at a curvature radius of 1.5 mm until delamination occurs. Specifically, the laminated sheet may withstand 200,000 times or more of repeated folding until delamination occurs. Within the above range, it can be advantageously applied to a flexible display device since it is not deformed even upon repeated folding when exposed to UV light.

In addition, the total content of the UV blocking agent in the laminated sheet may be 0.5 part by weight or more, 0.7 part by weight or more, 0.9 part by weight or more, 1.1 parts by weight or more, or 1.3 parts by weight or more, relative to 100 parts by weight of the polyester resin employed in the laminated sheet. In addition, the total content of the UV blocking agent in the laminated sheet may be 2.4 parts by weight or less, 2.2 parts by weight or less, 2.0 parts by weight or less, 1.8 parts by weight or less, or 1.6 parts by weight or less, relative to 100 parts by weight of the polyester resin employed in the laminated sheet. Specifically, the total content of the UV blocking agent contained in the first polyester film and the second polyester film may be 0.7 part by weight to 2.0 parts by weight relative to 100 parts by weight of the polyester resin in the first polyester film and the second polyester film

When the laminated sheet is applied to a display device, the first polyester film may be located on the front side (outer side) and the second polyester film may be located on the rear side (inner side). That is, as shown in FIGS. 2a and 2b, when the laminated sheet (10) is applied to a display device (1), the second polyester film (100b) may be applied to face the display panel (20). As described above, the first polyester film may be used as a front protective film, and the second polyester film may be used as a rear protective film.

Since a front protective film has to protect the display device from external stimuli, the larger the thickness, the more advantageous. However, since a front protective film in a flexible display device is a part to which tensile or compressive force is the most applied, it is advantageous to have a low modulus for flexibility. Meanwhile, since a rear protection film is not directly stimulated from the outside, it may be thin. The flexibility may not be significantly impaired with a thin thickness even if its modulus is above a certain level.

Accordingly, the laminated sheet may satisfy the following Relationships (1) and (2):

1.5≤T1/T2 (1)

0.8≤M2/M1≤1.2 (2)

In the above relationships, T1 is the thickness of the first polyester film, T2 is the thickness of the second polyester film, M1 is the modulus (GPa) of the first polyester film in the transverse direction (TD), and M2 is the modulus (GPa) of the second polyester film in the transverse direction (TD).

T1/T2 may be 1.5 or more, 2.0 or more, 2.5 or more, or 3.0 or more, for example, 1.5 to 5.0 or 2.0 to 4.0. As an example, T1 may be 45 μm to 80 μm, and T2 may be 10 μm to 30 μm. M2/M1 may be 0.8 or more, 1.0 or more, greater than 1 0, 1.05 or more, or 1.1 or more, and it maybe 1.2 or less or 1.15 or less, for example, 1.05 to 1.2.

First and Second Polyester Films

The first polyester film and the second polyester film comprise a polyester resin. Examples of specific types and monomers (dicarboxylic acid and diol) of the polyester resin are the same as those described above for the polyester film.

The first polyester film comprises a UV blocking agent, and the second polyester film may, or may not, comprise a UV blocking agent. Specific types, chemical structures, and properties such as thermal resistance of the UV blocking agent are the same as those described above for the polyester film

As an example, the first polyester film and the second polyester film both may comprise a UV blocking agent. In such an event, the content of the UV blocking agent in the first polyester film or the second polyester film may be 0.5 part by weight or more, 0.7 part by weight or more, 0.9 part by weight or more, 1.1 parts by weight or more, or 1.3 parts by weight or more, relative to 100 parts by weight of the polyester resin employed in the respective polyester films In addition, the content of the UV blocking agent in the first polyester film or the second polyester film may be 2.4 parts by weight or less, 2.2 parts by weight or less, 2.0 parts by weight or less, 1.8 parts by weight or less, or 1.6 parts by weight or less, relative to 100 parts by weight of the polyester resin employed in the respective polyester films

As another example, the second polyester film may not, or may, comprise a trace amount of a UV blocking agent. In such an event, the content of the UV blocking agent contained in the second polyester film may be less than 0.5 part by weight or less than 0.1 part by weight relative to 100 parts by weight of the polyester resin employed in the second polyester film

According to an embodiment, the content of the UV blocking agent in the first polyester film may be 0.5 part by weight to 2.0 parts by weight relative to 100 parts by weight of the polyester resin employed in the first polyester film The content of the UV blocking agent contained in the second polyester film may be less than 0.1 part by weight relative to 100 parts by weight of the polyester resin employed in the second polyester film.

When the polyester film comprising a UV blocking agent is applied to a cover of a display device, it is advantageous for preventing deformation by protecting the internal components thereof from UV light.

The transmittance of the first and second polyester films for UV light may be the same as the transmittance of the polyester film for UV light exemplified above.

According to an embodiment, the first polyester film has a total transmittance of 2% to 5.5% for light having a wavelength of 370 nm, a total transmittance of 9.5% to 22% for light having a wavelength of 380 nm, a total transmittance of 65% to 85% for light having a wavelength of 390 nm, and a total transmittance of 85% to 95% for light having a wavelength of 550 nm. Within the above ranges, when the laminated sheet comprising the first polyester film is applied to a cover of a display device, it is advantageous for preventing deformation by protecting the internal components thereof from UV light.

In addition, the first polyester film may have an average rate of change in total transmittance (%) of 0.1%/nm to 1%/nm at a wavelength of 370 nm to 375 nm and an average rate of change in total transmittance (%) of 3%/nm to 10%/nm at a wavelength of385 nm to 390 nm.

In addition, in the first polyester film, the strain with respect to tensile load is adjusted to a specific range even upon exposure to UV light. As a result, it is possible for the laminated sheet comprising the first polyester film to maintain its original characteristics when applied to a cover of a flexible display device and subjected to a plurality of repeated folding upon exposure to UV light from the outside. The UV light may be, for example, UV-B light. The UV-B light may have a specific wavelength range of 280 nm to 315 nm. Specifically, the UV-B light has a peak wavelength within 310 nm to 315 nm, an irradiance of about 0.66 W/m² (e.g., 0.6 to 0.7 W/m²) at a wavelength of 310 nm, and a total irradiance of about 31.62 W/m² (e.g., 31.6 to 31.7 W/m²) in the wavelength band of 250 nm to 400 nm.

According to an embodiment, the first polyester film, upon irradiation with UV-B light for 24 hours, may have a final tensile rate of 3% or less when a load of N2% is applied for 1 hour in a first direction in the plane. Here, the load of N2% is a load that stretches the film by 2% relative to the initial state in the first direction. Specifically, the tensile rate may be measured at room temperature with an initial dimension of 50 mm (initial distance between points to which a tensile load is applied) of the film in the first direction and a dimension of 15 mm in a direction perpendicular thereto.

More specifically, (1) while the first polyester film having an initial dimension of 50 mm in a first direction in the plane and a dimension of 15 mm in a direction perpendicular thereto is stretched in the first direction, the load (N2%) at the time when the dimension increases by 2% relative to the initial dimension is first measured, and (2) the ratio of the dimension increased relative to the initial dimension when the load (N2%) is continuously applied to the film for 1 hour in the first direction, that is, the final tensile rate is 3% or less.

As an example, the first polyester film, upon irradiation with UV-B light for 24 hours, may have a final tensile rate of 3% or less, 2.7% or less, 2.5% or less, or 2.3% or less, when a load of N2% is applied for 1 hour. For example, the film, upon irradiation with UV-B light for 24 hours, may have a final tensile rate of 1.5% to 3%, 2% to 3%, 2.3% to 3%, 2% to 2.7%, or 2% to 2.5%, in a first direction and a second direction perpendicular to each other in the plane, respectively, when a load of N2% is applied for 1 hour. Specifically, the film, upon irradiation with UV-B light for 24 hours, may have a final tensile rate of 2% to 3% in a first direction and a second direction perpendicular to each other in the plane, respectively, when a load of N2% is applied for 1 hour.

As another example, the first polyester film, upon irradiation with UV-B light for 24 hours, may have a final tensile rate of 2% or less when a load of N1% is applied for 1 hour in a first direction in the plane. Here, the load of N1% is a load that stretches the film by 1% relative to the initial state in the first direction. For example, the film, upon irradiation with UV-B light for 24 hours, may have a final tensile rate of 1.7% or less, 1.5% or less, or 1.3% or less, when a load of N1% is applied for 1 hour. Specifically, the film, upon irradiation with UV-B light for 24 hours, may have a final tensile rate of 1.1% to 2%, 1.3% to 2%, 1.5% to 2%, 1.1% to 1.7%, or 1.1% to 1.5%, in a first direction and a second direction perpendicular to each other in the plane, respectively, when a load of N1% is applied for 1 hour. The tensile rate may be measured at room temperature with an initial dimension of 50 mm of the film in the first direction and a dimension of 15 mm in a direction perpendicular thereto.

As still another example, the first polyester film, upon irradiation with UV-B light for 24 hours, may have a final tensile rate of 7% or less when a load of N3% is applied for 1 hour in a first direction in the plane. Here, the load of N3% is a load that stretches the film by 3% relative to the initial state in the first direction. For example, the film, upon irradiation with UV-B light for 24 hours, may have a final tensile rate of 6.7% or less, 6.5% or less, 6.3% or less, 6% or less, or 5.7% or less, when a load of N3% is applied for 1 hour. Specifically, the film, upon irradiation with UV-B light for 24 hours, may have a final tensile rate of 3% to 7%, 5% to 7%, 5% to 6%, 5.5% to 6.5%, or 6% to 7%, in a first direction and a second direction perpendicular to each other in the plane, respectively, when a load of N3% is applied for 1 hour. The tensile rate may be measured at room temperature with an initial dimension of 50 mm of the film in the first direction and a dimension of 15 mm in a direction perpendicular thereto.

As a specific example, the first polyester film, upon irradiation with UV-B light for 24 hours, may have a final tensile rate of 2% or less when a load of N1% is applied for 1 hour in a first direction in the plane and a final tensile rate of 7% or less when a load of N3% is applied for 1 hour in a first direction in the plane. Here, the load of N1% or N3% is a load that stretches the film by 1% or 3% relative to the initial state in the first direction.

In addition, the second polyester film may have the same tensile characteristics as those of the first polyester film

The first direction may be any direction in the plane of the film, and the second direction may be determined in a direction in the plane perpendicular to the first direction. For example, the first direction may be the longitudinal direction (MD) or the transverse direction (TD) of the film, and the second direction may be the transverse direction (TD) or the longitudinal direction (MD) perpendicular thereto. Specifically, the first direction may be the longitudinal direction (MD) of the film, and the second direction may be the transverse direction (TD) of the film

The first and second polyester films are each preferably a biaxially stretched film from the viewpoint of flexibility and elastic restoring. In such an event, the ratio between the respective stretching ratios for the two directions may be 1:0.5 to 1:1.5, 1:0.7 to 1:1.3, or 1:0.8 to 1:1.2. Specifically, the first and second polyester films may be biaxially stretched, and the ratio between the respective stretching ratios in the two directions may be 1:0.8 to 1:1.2. If the ratio of stretching ratios is within the above range, it may be more advantageous for having flexibility in which deformation does not occur even if a certain load is maintained for a long period of time.

The first and second polyester films may be biaxially stretched in a first direction and in a second direction perpendicular to the first direction in the plane. In such an event, the stretching ratio in the first direction may be 2.0 to 5.0, specifically 2.8 to 3.5 or 3.3 to 3.5. In addition, the stretching ratio in the second direction may be 2.0 to 5.0, specifically 2.9 to 3.7 or 3.5 to 3.8. Specifically, the first and second polyester films may be biaxially stretched at a stretching ratio of 3.3 to 3.5 in the longitudinal direction and at a stretching ratio of 3.5 to 3.8 in the transverse direction. In addition, the ratio (d2/d1) of the stretching ratio in the second direction (d2) to the stretching ratio in the first direction (d1) may be 1.2 or less. For example, it may be 1.0 to 1.2, 1.0 to 1.1, 1.0 to 1.15, or 1.05 to 1.1.

The first polyester film and the second polyester film may each have a thickness of 10 μm to 500 μm, 10 μm to 300 μm, 10 μm to 100 μm, 10 μm to 80 μm, 20 μm to 80 μm, 30 μm to 80 μm, 40 μm to 60 μm, or 10 μm to 30 μm. As an example, when the first polyester film and the second polyester film are applied to front and rear protective films of a cover, respectively, the first polyester film may have a thickness of 20 μm to 80 μm, specifically, 60 μm to 80 μm, and the second polyester film may have a thickness of 30 μm or less, specifically, 10 μm to 30 μm.

Transparent Substrate

The transparent substrate may be a cover window of a display device.

The transparent substrate may be a polymer film or a glass substrate. Specifically, the transparent substrate may be a polyimide film or ultra-thin glass (UTG).

As an example, the transparent substrate may comprise a polyimide resin. Specifically, the transparent cover may be a polyimide-based film

The polyimide-based film comprises a polyimide-based polymer, which is prepared by polymerizing a diamine compound, a dianhydride compound, and, optionally, a dicarbonyl compound.

The polyimide-based polymer is a polymer that contains an imide repeat unit. In addition, the polyimide-based polymer may optionally comprise an amide repeat unit. The polyimide-based polymer may be prepared by simultaneously or sequentially reacting reactants that comprise a diamine compound and a dianhydride compound. Specifically, the polyimide-based polymer is prepared by polymerizing a diamine compound and a dianhydride compound. Alternatively, the polyimide-based polymer is prepared by polymerizing a diamine compound, a dianhydride compound, and a dicarbonyl compound. Here, the polyimide-based polymer comprises an imide repeat unit derived from the polymerization of the diamine compound and the dianhydride compound and an amide repeat unit derived from the polymerization of the diamine compound and the dicarbonyl compound.

The diamine compound may be, for example, an aromatic diamine compound that contains an aromatic structure. Specifically, the diamine compound may comprise 2,2′-bis(trifluoromethyl)-4,4′-diaminobiphenyl (TFDB), but it is not limited thereto.

The dianhydride compound may be, for example, an aromatic dianhydride compound that contains an aromatic structure or an alicyclic dianhydride compound that contains an alicyclic structure. Specifically, the dianhydride compound may comprise 2,2′-bis-(3,4-dicarboxyphenyl)hexafluoropropane dianhydride (6-FDA), but it not limited thereto.

The dicarbonyl compound may be an aromatic dicarbonyl compound that contains an aromatic structure. The dicarbonyl compound may comprise terephthaloyl chloride (TPC), 1,1′-biphenyl-4,4′-dicarbonyl dichloride (BPDC), isophthaloyl chloride (IPC), or a combination thereof. But it is not limited thereto.

The diamine compound and the dianhydride compound may be polymerized to form a polyamic acid. Subsequently, the polyamic acid may be converted to a polyimide through a dehydration reaction, and the polyimide comprises an imide repeat unit.

For example, the polyimide may comprise a repeat unit represented by the following Formula A-1, but it is not limited thereto.

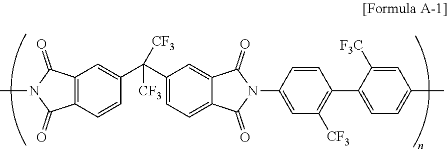

In Formula A-1, n is, for example, an integer of 1 to 400.

In addition, the diamine compound and the dicarbonyl compound may be polymerized to form amide repeat units represented by the following Formulae B-1 to B-3.

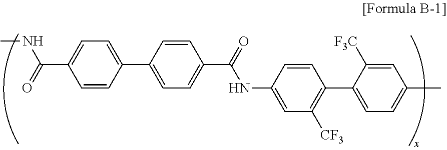

In Formula B-1, x is, for example, an integer of 1 to 400.

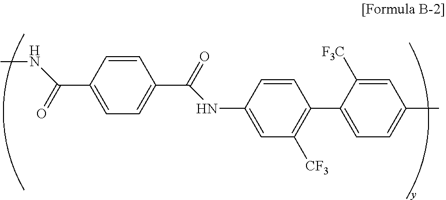

In Formula B-2, y is, for example, an integer of 1 to 400.

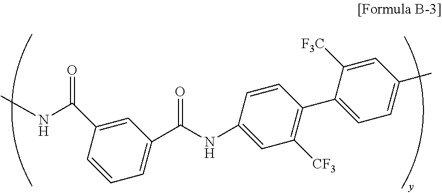

In Formula B-3, y is, for example, an integer of 1 to 400.

The thickness of the transparent substrate may be 20 μm to 500 μm, 30 μm to 300 μm, or 40 μm to 100 μm.

The transparent substrate may have a surface hardness of HB or higher and a light transmittance of 80% or more at a wavelength of 550 nm. In addition, the transparent substrate may have a yellow index of 5 or less and a haze of 2% or less based on a thickness of 50 μm.

The transparent substrate may have a strain of 10% or more, 12% or more, 15% or more, or 20% or more, until whitening occurs. Within the above range, it can be advantageously applied to a flexible display device since no whitening occurs despite deformation upon frequent folding. The strain refers to the ratio of a changed dimension to an initial dimension of a film Here, the changed dimension may be an increased dimension or a decreased dimension. In particular, the protective film and the transparent substrate may each have a strain of 10% or more until whitening occurs.

Adhesive Layer and Coating Layer

The laminated sheet may further comprise an adhesive layer between the transparent substrate and the first polyester film and between the transparent substrate and the second polyester film.

The adhesive layer may have a thickness of 1μm to 50 μm, 3μm to 30 μm, 5 μm to 20 μm, 5 μm to 15 μm, 7 μm to 12 μm, or 8 μm to 12 μm. Specifically, the adhesive layer may have a thickness of 5 μm to 15 μm. Within the above preferred thickness range, it may be more advantageous for suppressing curl with excellent interfacial adhesion.

The adhesive layer comprises an adhesive resin and may further comprise a curing agent and/or a photoinitiator. The adhesive resin is not particularly limited. For example, it may be a resin that can be cured by irradiation of UV light, so that the adhesive layer may be prepared through UV curing. In addition, the adhesive resin may be a resin that is not yellowed by UV light and has good dispersibility of a UV absorber. For example, the adhesive resin may be a polyester resin, an acrylic resin, an alkyd resin, an amino resin, or the like. The adhesive resin may be used alone or as a copolymer or a mixture of two or more kinds thereof. An acrylic resin among them is preferable since it is excellent in optical properties, weatherability, adhesion to a substrate, and the like. In addition, the adhesive resin may be an optical clear adhesive (OCA).

The curing agent is not particularly limited as long as it is a substance capable of curing the adhesive resin. Specifically, it may be at least one selected from the group consisting of an isocyanate curing agent, an epoxy curing agent, and an aziridine curing agent, which are not yellowed by UV light. In addition, the curing agent may be employed in an amount of 0.2 to 0.5% by weight, 0.3 to 0.5% by weight, 0.3 to 0.45% by weight, or 0.35 to 0.45% by weight, based on the weight of each of the adhesive layers.

The photoinitiator is required for UV curing. For example, it may be at least one selected from the group consisting of benzophenone-based, thioxanthone-based, a-hydroxy ketone-based, ketone-based, phenyl glyoxylate-based, and acryl phosphine oxide-based compounds. The photoinitiator may be employed in an amount of 0.1 to 5.0% by weight based on the weight of the respective adhesive layers.

In addition, the laminated sheet may further comprise at least one coating layer disposed on the first polyester film or the second polyester film The coating layer may be disposed between the polyester film and the transparent substrate or disposed on the outer side of the protective film The coating layer may be a functional coating layer for hardness enhancement, antistatic, scattering prevention, refractive index adjustment, surface protection, or the like.

Process for Preparing a Laminated Sheet

The lamination sheet may be prepared by a process of preparing a polyester film and then laminating it on both sides of a transparent substrate using an adhesive.

The process for preparing a laminated sheet according to an embodiment comprises preparing a first polyester film and a second polyester film; forming an adhesive layer on one side of the first polyester film and the second polyester film, respectively; and laminating the first polyester film and the second polyester film on which the adhesive layer is formed on one side and the other side of a transparent substrate, respectively.

The first and second polyester films may be prepared by a process comprising biaxial stretching at an adjusted stretching ratio and thermal treatment at a specific temperature using a resin composition. Here, a UV blocking agent may be added to the resin composition. The amount thereof may be adjusted as exemplified above. In particular, the process for preparing the first and second polyester films comprises forming a film from a resin composition and biaxially stretching and thermally treating it to obtain a film having a final tensile rate of 3% or less when a load of N2% is applied for 1 hour. Here, the composition and process conditions are adjusted such that the film finally produced by the above process satisfies the tensile characteristics described above. Specifically, in order for the final film to satisfy the above characteristics, the extrusion and casting temperatures of the polyester resin are adjusted, the preheating temperature at the time of stretching, the stretching ratio in each direction, the stretching temperature, the transferring speed, and the like are adjusted, or thermal treatment and relaxation are carried out after the stretching while the thermal treatment temperature and relaxation rate are adjusted.

The specific process and conditions in each step for preparing the first and second polyester films, respectively, may be the same as the specific process and conditions in each step of the process for preparing a polyester film as described above.

An adhesive is applied on one side of the first and second polyester films prepared in this way, respectively, which may then be laminated on both sides of a transparent substrate.

Flexible Display Device

The flexible displace device according to an embodiment comprises the polyester film or laminated sheet described above in a cover.

The flexible display device according to an embodiment comprises a flexible display panel; and the polyester film disposed on the flexible display panel. The flexible display device according to another embodiment comprises a flexible display panel; and the laminated sheet disposed on the flexible display panel.

The polyester film or laminated sheet adopted in the flexible displace device has substantially the same configuration and characteristics as those of the polyester film or the laminated sheet as described above.

Specifically, the polyester film has a total transmittance of 5% or less for light having a wavelength of 370 nm and a final tensile rate of 3% or less when a load of N2% is applied for 1 hour in a first direction in the plane upon irradiation with UV-B light for 24 hours. Here, the load of N2% is a load that stretches the film by 2% relative to the initial state in the first direction, the UV-B light has a peak wavelength within 310 nm to 315 nm, an irradiance of 0.66 W/m² at a wavelength of 310 nm, and a total irradiance of 31.62 W/m² in the wavelength band of 250 nm to 400 nm.

In addition, the laminated sheet comprises a transparent substrate disposed on the display panel; a first polyester film disposed on the transparent substrate; and a second polyester film disposed under the transparent substrate, wherein the first polyester film comprises (i) 0.5 part by weight to 2.0 parts by weight of a UV blocking agent relative to 100 parts by weight of the polyester resin employed in the first polyester film and has (ii) a total transmittance of 2% to 5.5% for light having a wavelength of 370 nm, (iii) a total transmittance of 9.5% to 22% for light having a wavelength of 380 nm, (iv) a total transmittance of 65% to 85% for light having a wavelength of 390 nm, and (v) a total transmittance of 85% to 95% for light having a wavelength of 550 nm.

According to the above embodiment, a UV blocking agent is added to at least one of the two polyester films provided in the laminated sheet, whereby it is possible to prevent the poor or deformed appearance or the occurrence of device defects during exposure to UV light for long-term use.

The flexible display device may be a foldable display device. Specifically, the foldable display device may be an in-folding type or an out-folding type depending on the folding direction. Referring to FIGS. 1a and 1b, such foldable display devices are developed as an in-folding type (1a) in which a screen is positioned inside the folding direction and an out-folding type (1b) in which a screen is positioned outside the folding direction.

In a material applied to flexible display devices, it is as important as flexibility that the original characteristics are not deteriorated despite frequent bending or folding. When a conventional material is completely folded and then unfolded, there remains a mark, and it is almost impossible to return to the original state. Thus, the development of materials applied to flexible display devices should be accompanied by characteristics to overcome this limitation.

Specifically, whitening or cracks may occur in the cover (10), which deteriorates the characteristics thereof, due to the deformation caused by a load applied to the point (p1) of inward folding in the in-folding type (1a) as shown in FIG. 1a and due to the deformation caused by a load applied to the point (p2) of outward folding in the out-folding type (1b) as shown in FIG. 1b. Such whitening and cracks can generally be solved when the modulus of the protective film is small at room temperature. In general, conventional polyester films or covers provided with the same have a large modulus at room temperature, so that they have the problem that whitening and cracks are easily generated when applied to flexible display devices.

However, the polyester film according to an embodiment can achieve the characteristics required for a cover of a flexible display by adjusting the strain with respect to the tensile load upon irradiation with UV light to a specific range. As a result, the polyester film according to an embodiment and the laminated sheet comprising the same can maintain their original characteristics when applied to a cover of a flexible display device and subjected to a plurality of repeated folding upon exposure to UV light.

In addition, the laminated sheet according to an embodiment can achieve the flexibility required for a cover of a flexible display by adjusting the mechanical properties of the polyester film and other constitutional layers adopted therein to specific ranges upon exposure to UV light. As a result, it is possible for the laminated sheet according to an embodiment to maintain its original characteristics when applied to a cover of a flexible display device and subjected to a plurality of repeated folding.

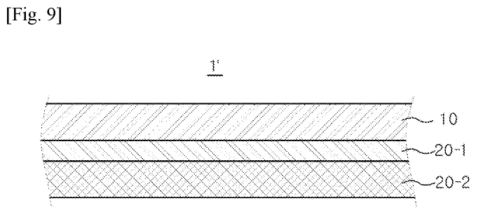

In the flexible display device, the flexible display panel may be specifically an organic light emitting display (OLED) panel. FIG. 9 schematically shows an example of a cross-sectional view of an organic light emitting display device (1′), which comprises an organic light emitting display panel (20-2). Referring to FIG. 9, the organic light emitting display (1′) comprises a front polarizing plate (20-1) and an organic light emitting display panel (20-2). The front polarizing plate may be disposed on the front side of the organic light emitting display panel. In more detail, the front polarizing plate may be bonded to the side of the organic light emitting display panel where an image is displayed. The organic light emitting display panel displays an image by self-emission of a pixel unit. The organic light emitting display panel comprises an organic light emitting substrate and a driving substrate. The organic light emitting substrate comprises a plurality of organic light emitting units that correspond to respective pixels. The organic light emitting units each comprise a cathode, an electron transport layer, a light emitting layer, a hole transport layer, and an anode. The driving substrate is operatively coupled to the organic light emitting substrate. That is, the driving substrate may be coupled to the organic light emitting substrate so as to apply a driving signal such as a driving current. More specifically, the driving substrate may drive the organic light emitting substrate by applying a current to each of the organic light emitting units.

### Mode for the Invention

Hereinafter, more specific embodiments will be described, but the scope of implementation is not limited thereto.

Evaluation Example of UV Blocking Agents

Thermogravimetric analyzer (TGA) evaluation was carried out to select a UV blocking agent with excellent processing efficiency even at the processing temperature of polyethylene terephthalate (PET) resins. The suitability of the UV blocking agents was determined as pass if the weight loss did not exceed 15% after being maintained for 1 hour under an isothermal condition of 280° C. in an air atmosphere using Q500 equipment from TA Instruments and as failure otherwise.

TABLE 1

| | | TGA evaluation |
|---|---|---|
| | Name | result |
| UV blocking agent 1 | Benzophenone-3 | Failure |
| UV blocking agent 2 | Phenol, 2-(2H-benzotriazol- | Failure |
| | 2-yl)-4-methyl | |
| UV blocking agent 3 | 2,2′-(1,4-Phenylene)bis(4H- | Pass |
| | 3,1-benzoxazin-4-one) | |

Preparation Example of a Polyester Film

A composition in which a UV blocking agent as shown in the following table was added to a polyethylene terephthalate (PET) resin as shown in Table 2 was extruded at 280° C. and then cast through a T-die into a film shape. The cast film was preheated at 100° C. and stretched 3.0 times in the longitudinal direction (MD) and 3.3 times in the transverse direction (TD). Here, the stretching temperature was 130° C. Thereafter, the stretched film was heat set at 200° C., relaxed by 3%, and cooled to prepare a polyester film having a thickness of 60 μm. In addition, as a comparative example, a polyester film was prepared in the same manner as above without a UV blocking agent.

TABLE 2

| | | PET resin composition | |
|---|---|---|---|
| | | | Content of UV |
| | | | blocking agent |
| | | Type of UV blocking agent | (part by weight)* |
| Film A1 | C. Ex. 1 | — | — |
| Film A2 | C. Ex. 2 | UV blocking agent 1 | 1.3 |
| Film B1 | Ex. 1 | UV blocking agent 3 | 1.1 |
| Film B2 | Ex. 2 | UV blocking agent 3 | 1.6 |
| Film B3 | Ex. 3 | UV blocking agent 3 | 0.9 |
| Film B4 | Ex. 4 | UV blocking agent 3 | 0.8 |
| Film B5 | Ex. 5 | UV blocking agent 3 | 0.8 |

*Content of UV blocking agent: parts by weight of the solids content of the UV blocking agent added per 100 parts by weight of the PET resin

Test Example of Total Transmittance

The total transmittance was measured for the polyester film samples as follows.
Measuring equipment: Ultrascan pro Colorimeter of Hunterlab
Measurement procedure: ASTM D1003
Light source: D65/10
Diffusion angle: 8°

The results are shown in the table below.

TABLE 3

Total transmittance (%)

| | | 370 nm | 380 nm | 390 nm | 550 nm |
|---|---|---|---|---|---|
| Film A1 | C. Ex. 1 | 75 | 81 | 87.8 | 93.2 |
| Film A2 | C. Ex. 2 | 5.8 | 18.5 | 72.1 | 92.9 |
| Film B1 | Ex. 1 | 3.81 | 11.5 | 70.7 | 93.2 |
| Film B2 | Ex. 2 | 3.5 | 9.7 | 71.3 | 92.9 |
| Film B3 | Ex. 3 | 3.9 | 16.5 | 68.7 | 92.9 |
| Film B4 | Ex. 4 | 3.98 | 19.1 | 70.9 | 93.1 |
| Film B5 | Ex. 5 | 3.97 | 19.6 | 71.1 | 93.2 |

Test example of tensile rate

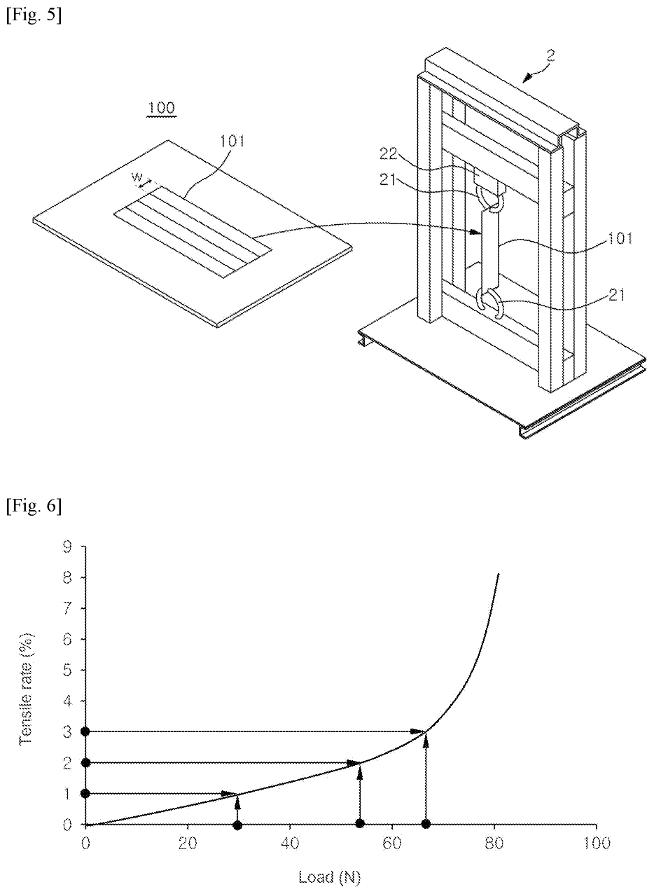

The tensile rate was measured for the polyester films as follows. Referring to FIG. 5, 4 pieces of a rectangular specimen (101) adjacent to each other were cut in a width (w) of 15 mm from a polyester film (100). Both ends of the specimen (101) were fixed to the jigs (21) of the test equipment (2). Thereafter, the tensile rate was measured under the following conditions and procedures.
Initial dimension in tensile direction: 50 mm
Dimension in a direction perpendicular to the tensile direction: 15 mm
Test temperature: room temperature (25° C.)
Test equipment: UTM 5566A of Instron
Tensile speed: 50 mm/min 1

Tensile direction: longitudinal direction (MD) or transverse direction (TD) of a polyester film

(1) Measurement of the load by initial tensile rate

First, the respective loads for stretching a specimen by 1%, 2%, and 3%, relative to the initial dimension were measured.

(2) Measurement of the final tensile rate at a sustained load

Thereafter, the load measured above was applied to the specimen for 1 hour, and the final tensile rate (%) relative to the initial dimension of the specimen was measured.

(3) The procedures of (1) and (2) above were carried out for 4 specimens, and the average value was taken. The results are shown in the table below.

Test Example of Tensile Rate Upon Irradiation with UV Light

The tensile rate upon irradiation with UV light was measured under the following conditions.

(a) UV irradiation
UV equipment: QUV Tester of Q-lab
UV lamp: UVB-313
UV dose: 0.66 W/m² at 310 nm
UV total dose: 31.62 W/m² at 250 to 400 nm
UV irradiation time: 24 hours

(b) The tensile rate of the UV-irradiated specimen was measured in the same manner as above.

The results are shown in the table below.

Test Example of Elongation at Break Upon UV Irradiation for a Laminated Sheet of Two Layers

Two sheets of the same polyester film were laminated. One side thereof was irradiated with UV light, and the elongation at break of the film located on the opposite side was measured. Here, the UV irradiation was carried out in the same manner as above, and the elongation at break was measured by measuring the tensile rate at break while the specimen was elongated under the same equipment and conditions as above for measuring tensile rates. The results are shown in the table below.

TABLE 4

| | | | | | | | Elongation at break of | |
|---|---|---|---|---|---|---|---|---|
| | | | | | | | a laminated sheet | |
| | | Initial | Tensile rate after 1 hour (%) | | | | having two layers upon | |
| | | tensile rate | Before UV irradiation | | After UV irradiation | | UV irradiation | |
| | | (%) | MD | TD | MD | TD | MD | TD |
| Film A1 | C. Ex. 1 | 1 | 1.2 | 1.21 | 1.67 | 2.11 | 7 | 8 |
| | | 2 | 2.4 | 2.38 | 3.1 | 3.57 | | |
| | | 3 | 5.80 | 5.91 | 7.13 | 7.9 | | |
| Film A2 | C. Ex. 2 | 1 | 1.33 | 1.41 | 1.71 | 1.99 | 132 | 83 |
| | | 2 | 2.15 | 2.67 | 2.81 | 3.21 | | |
| | | 3 | 4.97 | 5.93 | 6.37 | 7.13 | | |
| Film B1 | Ex. 1 | 1 | 1.11 | 1.15 | 1.17 | 1.21 | 141 | 97 |
| | | 2 | 2.37 | 2.69 | 2.38 | 2.66 | | |
| | | 3 | 5.11 | 6.7 | 5.36 | 6.91 | | |
| Film B2 | Ex. 2 | 1 | 1.31 | 1.32 | 1.31 | 1.35 | 138 | 101 |
| | | 2 | 2.48 | 2.91 | 2.49 | 2.91 | | |
| | | 3 | 5.31 | 6.72 | 5.33 | 6.71 | | |
| Film B3 | Ex. 3 | 1 | 1.16 | 1.17 | 1.23 | 1.25 | 140 | 96 |
| | | 2 | 2.31 | 2.67 | 2.47 | 2.82 | | |
| | | 3 | 4.09 | 5.11 | 4.66 | 5.93 | | |
| Film B4 | Ex. 4 | 1 | 1.16 | 1.23 | 1.19 | 1.24 | 129 | 89 |
| | | 2 | 2.3 | 2.35 | 2.53 | 2.78 | | |
| | | 3 | 4.6 | 5.7 | 5.21 | 6.37 | | |
| Film B5 | Ex. 5 | 1 | 1.11 | 1.18 | 1.21 | 1.67 | 139 | 93 |
| | | 2 | 2.2 | 2.45 | 2.57 | 2.91 | | |
| | | 3 | 5.31 | 6.21 | 6.27 | 6.91 | | |

Preparation Example of a Laminated Sheet

Films having a thickness of 60 μm were prepared in the same manner as polyester films A1 to B5 above, respectively. They were each used as a first polyester film In addition, films having a thickness of 15 to 20 μm were prepared without a UV blocking agent in the same manner as in film A1. It was used as a second polyester film An optically clear adhesive (OCA) was coated on one side of the first polyester film and one side of the second polyester film to a thickness of 10 μm, respectively. They were laminated on both sides of a cover window. A transparent polyimide film (see Preparation Example below) having a thickness of 50 μm was used as the cover window. As a result, a laminated sheet having a structure of first polyester film/OCA layer/cover window/OCA layer/second polyester film was obtained.

TABLE 5

| | | First polyester film | | | Second polyester film | |
|---|---|---|---|---|---|---|
| | | | UV blocking | | UV blocking | |
| | | Preparation | agent | Thickness | agent | Thickness |
| | | method | Content* | (μm) | Content* | (μm) |
| Sheet A1 | C. Ex. 1 | Film A1 | 0 | 60 | 0 | 20 |
| Sheet A2 | C. Ex. 2 | Film A2 | 1.3 | 60 | 0 | 20 |
| Sheet B1 | Ex. 1 | Film B1 | 1.1 | 60 | 0 | 20 |
| Sheet B2 | Ex. 2 | Film B2 | 1.6 | 60 | 0 | 15 |
| Sheet B3 | Ex. 3 | Film B3 | 0.9 | 60 | 0 | 15 |
| Sheet B4 | Ex. 4 | Film B4 | 0.8 | 60 | 0 | 17 |
| Sheet B5 | Ex. 5 | Film B5 | 0.8 | 60 | 0 | 17 |

*Content of UV blocking agent: parts by weight of the solids content of the UV blocking agent added per 100 parts by weight of the PET resin

Preparation Example of a Polyimide Film

A 1-liter glass reactor equipped with a temperature-controllable double jacket was charged with 563.3 g of dimethylacetamide (DMAc) as an organic solvent at 20° C. under a nitrogen atmosphere. Then, 2,2′-bis(trifluoromethyl)-4,4′-diaminobiphenyl (TFMB) and 4,4′-oxydianiline (ODA) were slowly added thereto for dissolution thereof. Subsequently, 2,2′-bis(3,4-dicarboxyphenyl)hexafluoropropane dianhydride (6FDA) was slowly added thereto, and the mixture was stirred for 2 hours. Then, isophthaloyl chloride (IPC) was added, followed by stirring for 2 hours. And terephthaloyl chloride (TPC) was added, followed by stirring for 3 hours, thereby preparing a polymer solution.

The polymer solution thus obtained was coated onto a glass plate and then dried with hot air at 80° C. for 30 minutes. Thereafter, the dried gel sheet was fixed to a pin frame while it was stretched by 1.01 times in a first direction and stretched by 1.03 times in a second direction perpendicular to the first direction. Thereafter, while the dried gel sheet was fixed to the pin frame, it was cured in an atmosphere heated at a rate of 2° C/min in a temperature range of 80° C. to 300° C. Thereafter, it was cooled to obtain a polyimide film having a thickness of 50 μm.

Test Example of Modulus for a Laminated Sheet

Specimens were prepared by cutting each of the first polyester film, cover window, and second polyester film constituting the laminated sheet prepared above. The modulus, i.e., Young's modulus, was measured.
Initial dimension in tensile direction: 50 mm
Dimension in a direction perpendicular to the tensile direction: 15 mm 1

Test temperature: room temperature (25° C.)
Test equipment: UTM 5566A of Instron
Tensile speed: 50 mm/min
Tensile direction: longitudinal direction (MD) or transverse direction (TD)

TABLE 6

| | | Modulus (GPa) (25° C.) | | | | | |
|---|---|---|---|---|---|---|---|
| | | First polyester film | | Cover window | | Second polyester film | |
| | | MD | TD | MD | TD | MD | TD |
| Sheet A1 | C. Ex. 1 | 4.1 | 4.6 | 5.6 | 5.8 | 3.9 | 5.1 |
| Sheet A2 | C. Ex. 2 | 3.9 | 4.5 | 5.8 | 5.7 | 4.1 | 4.6 |
| Sheet B1 | Ex. 1 | 4.3 | 4.7 | 6.3 | 6.6 | 3.9 | 5.2 |
| Sheet B2 | Ex. 2 | 4.1 | 4.6 | 5.9 | 6.1 | 4.0 | 5.1 |
| Sheet B3 | Ex. 3 | 4.2 | 4.7 | 5.7 | 6.3 | 4.1 | 5.2 |
| Sheet B4 | Ex. 4 | 4.3 | 4.8 | 6.9 | 6.7 | 3.9 | 5.2 |
| Sheet B5 | Ex. 5 | 4.2 | 4.7 | 6.7 | 6.6 | 4.1 | 5.3 |

Folding Characteristics upon UV Irradiation

The laminated sheet prepared above was attached to one side of a display panel to prepare a display module, which was then subjected to UV irradiation and a folding durability test as shown in FIG. 4.

(1) UV irradiation
UV equipment: QUV Tester of Q-lab
UV lamp: UVB-313
UV dose: 0.66 W/m² at 310 nm
UV total dose: 31.62 W/m² at 250 to 400 nm
UV irradiation time: 24 hours

(2) Folding test
Test equipment: MIT-DOA of Toyoseiki
Radius of curvature (R): 1 5 mm
Folding test procedure: MIT folding test according to ASTM D 2176 and TAPPI T 511
Criteria: If delamination, driving error, whitening, or other defects were observed after repeated folding of 200,000 times, it was evaluated as ×. If not, it was evaluated as ∘.

The results are shown in the table below.

TABLE 7

| | | Folding durability |
|---|---|---|
| Sheet A1 | C. Ex. 1 | x |
| Sheet A2 | C. Ex. 2 | x |
| Sheet B1 | Ex. 1 | ∘ |
| Sheet B2 | Ex. 2 | ∘ |
| Sheet B3 | Ex. 3 | ∘ |
| Sheet B4 | Ex. 4 | ∘ |
| Sheet B5 | Ex. 5 | ∘ |

As can be seen from the above table, the display module comprising sheet Al or A2, upon UV irradiation, had defects during repeated folding of 200,000 times or more. In contrast, in the display module comprising any of sheets B1 to B5, upon UV irradiation, defects such as delamination, driving error, and whitening were not observed during repeated folding of 200,000 times or more; thus, the UV durability and flexibility were excellent.

1. A polyester film having a total transmittance of 5% or less for light having a wavelength of 370 nm and, upon irradiation with UV-B light for 24 hours, a final tensile rate of 3% or less when a load of N2% is applied for 1 hour in a first direction in the plane,
wherein the load of N2% is a load that stretches the film by 2% relative to the initial state in the first direction, the UV-B light has a peak wavelength within 310 nm to 315 nm, an irradiance of 0.66 W/m² at a wavelength of 310 nm, and a total irradiance of 31.62 W/m² in the wavelength band of 250 nm to 400 nm.

2. The polyester film of claim 1, which has a total transmittance of 20% or less for light having a wavelength of 380 nm.

3. The polyester film of claim 1, which comprises 100 parts by weight of a polyester resin; and 0.7 part by weight to 2.0 parts by weight of a UV blocking agent.

4. The polyester film of claim 3, wherein the UV blocking agent has a weight reduction rate of 15% or less when maintained for 1 hour in an air atmosphere at 280° C. under isothermal conditions of a thermogravimetric analyzer (TGA).

5. The polyester film of claim 3, wherein the UV blocking agent is at least one UV blocking agent selected from the group consisting of benzophenones, benzotriazoles, triazines, malonic acid esters, benzoates, and benzoxazinones.

6. The polyester film of claim 1, which has a thickness of 10 μm to 80 μm.

7. The polyester film of claim 1, which, upon irradiation with UV-B light for 24 hours, has a final tensile rate of 2% or less when a load of N1% is applied for 1 hour in a first direction in the plane and a final tensile rate of 7% or less when a load of N3% is applied for 1 hour in a first direction in the plane,
wherein the load of N1% or N3% is a load that stretches the film by 1% or 3% relative to the initial state in the first direction.

8. The polyester film of claim 1, wherein when two sheets of the polyester film are superposed and UV-B light is irradiated on one of the films for 24 hours, the other film has an elongation at break in the longitudinal direction (MD) of 125% or more and an elongation at break in the transverse direction (TD) of 85% or more.

9. The polyester film of claim 1, which, upon irradiation with UV-B light for 24 hours, withstands 200,000 times or more of repeated folding at a curvature radius of 1.5 mm until whitening or cracks occur.

10. A laminated sheet, which comprises a transparent substrate; a first polyester film disposed on one side of the transparent substrate; and a second polyester film disposed on the other side of the transparent substrate,
wherein the first polyester film comprises (i) 0.5 part by weight to 2.0 parts by weight of a UV blocking agent relative to 100 parts by weight of the polyester resin employed in the first polyester film and has (ii) a total transmittance of 2% to 5.5% for light having a wavelength of 370 nm, (iii) a total transmittance of 9.5% to 22% for light having a wavelength of 380 nm, (iv) a total transmittance of 65% to 85% for light having a wavelength of 390 nm, and (v) a total transmittance of 85% to 95% for light having a wavelength of 550 nm.

11. The laminated sheet of claim 10, wherein the content of the UV blocking agent contained in the second polyester film is less than 0.1 part by weight relative to 100 parts by weight of the polyester resin employed in the second polyester film

12. The laminated sheet of claim 10, wherein the UV blocking agent has a weight reduction rate of 15% or less when maintained for 1 hour in an air atmosphere at 280° C. under isothermal conditions of a thermogravimetric analyzer (TGA).

13. The laminated sheet of claim 10, which satisfies the following Relationships (1) and (2):
1.5≤T1/T2 (1)
0.8≤M2/M1≤1.2 (2)
in the above relationships, T1 is the thickness of the first polyester film, T2 is the thickness of the second polyester film, M1 is the modulus (GPa) of the first polyester film in the transverse direction (TD), and M2 is the modulus (GPa) of the second polyester film in the transverse direction (TD).

14. The laminated sheet of claim 10, wherein the UV blocking agent is at least one compound having a structure of the following Formula 1: 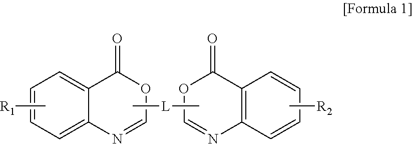
in the above formula, R₁ and R₂ are each independently hydrogen, alkyl, or alkenyl, and L is a single bond or a hydrocarbon chain, hydrocarbon ring, or heterocyclic ring having one or more unsaturated bonds.

15. The laminated sheet of claim 10, wherein the first polyester film has a thickness of 20 μm to 80 μm, and the second polyester film has a thickness of 30 μm or less.

16. The laminated sheet of claim 10, wherein the first polyester film, upon irradiation with UV-B light for 24 hours, has a final tensile rate of 3% or less when a load of N2% is applied for 1 hour in a first direction in the plane,
wherein the load of N2% is a load that stretches the film by 2% relative to the initial state in the first direction, the UV-B light has a peak wavelength within 310 nm to 315 nm, an irradiance of 0.66 W/m² at a wavelength of 310 nm, and a total irradiance of 31.62 W/m² in the wavelength band of 250 nm to 400 nm.

17. The laminated sheet of claim 10, which, upon irradiation with UV-B light for 24 hours, withstands 200,000 times or more of repeated folding at a curvature radius of 1.5 mm until delamination occurs.

18. The laminated sheet of claim 10, wherein the transparent cover is a polyimide-based film or ultra-thin glass (UTG).

19. A flexible display device, which comprises a flexible display panel; and the polyester film of claim 1 disposed on the flexible display panel.

20. A flexible display device, which comprises a flexible display panel; and a laminated sheet disposed on the flexible display panel,
wherein the laminated sheet comprises a transparent substrate disposed on the flexible display panel; a first polyester film disposed on the transparent substrate; and a second polyester film disposed under the transparent substrate,
wherein the first polyester film comprises (i) 0.5 part by weight to 2.0 parts by weight of a UV blocking agent relative to 100 parts by weight of the polyester resin contained in the first polyester film and has (ii) a total transmittance of 2% to 5.5% for light having a wavelength of 370 nm, (iii) a total transmittance of 9.5% to 22% for light having a wavelength of 380 nm, (iv) a total transmittance of 65% to 85% for light having a wavelength of 390 nm, and (v) a total transmittance of 85% to 95% for light having a wavelength of 550 nm.
